(19) United States
(12) Patent Application Publication
(10) Pub. No.: US 2026/0273918 A1
(43) Pub. Date: Sep. 17, 2026

(54) Hybrid Screen Printng System

(71) Applicant: Juan Carlos Tapia Vieyra, Tijuana (MX)

(72) Inventor: Juan Carlos Tapia Vieyra, Tijuana (MX)

(21) Appl. No.: 19/306,698

(22) Filed: Aug. 21, 2025

(30) Foreign Application Priority Data
Aug. 23, 2024 (MX) MX/U/2024/000354

(51) Int. Cl. B41F 15/02; B41F 15/42; B41F 15/46; F16C 29/00

(52) U.S. Cl. CPC B41F 15/02; B41F 15/423; B41F 15/46; F16C 29/005; F16C 2324/16

(57) ABSTRACT

A hybrid screen printing system with auxiliary mechanical systems can help to perform screen printing. The hybrid screen printing system comprises a printing mechanism mounted on two linear bearings on which the printing mechanism is mounted. The printing mechanism has angle adjustments, as well as mechanical stops to adjust the limit travel of both the ink squeegee and the printing squeegee. The printing mechanism is manually operated, so that allows the ink preparation, preparing it for the subsequent cycle change to deposit the ink onto the product to be printed. Regardless of the screen printing operator's prior inexperience, they can quickly adapt to this printing mechanism thanks to its auxiliary mechanisms that facilitate its use.

### FIELD OF THE INVENTION

The present invention relates to the field of screen printing, specifically to the manual screen printing process.

### BACKGROUND OF THE INVENTION

Currently, manual screen printing is done using a squeegee, which is used to deposit ink onto the product to be printed. Based on a study, it was found that the manual printing method generates fatigue in screen printing operators. It was also found that the learning curve for a printing operator is long because the technique is completely manual and involves applying a specific force and angle to achieve print quality. Noting the need to improve the manual screen printing process, a mechanism was devised to help reduce operator fatigue and more easily control movements during the printing process, thus achieving high-quality, repeatable prints. Although automated mechanisms for this operation are already available, they are too expensive and beyond the reach of many screen printing shops. This hybrid printing system addresses the need for a mechanism that allows screen printing operators to improve print quality. It is a mechanism that allows them to control movements during the printing process and is extremely easy for screen printers to operate. The components and characteristic details of this device are clearly shown in the following description and accompanying drawings.

### BRIEF DESCRIPTION OF THE INVENTION

The present invention relates to a hybrid screen printing system (100) that allows the operator to perform two printing phases: a preparation phase, in which the ink is distributed on the printing screen by using an ink squeegee, and a printing phase, in which the squeegee deposits the ink on the product. The change between both phases is carried out manually by a change lever (13), which alternates the position of an ink squeegee (21) and a print squeegee (19).

### BRIEF DESCRIPTION OF THE FIGURES

FIG. 1 is a perspective view of the hybrid screen printing system.

FIG. 2 is a side view of the screen printing mechanism.

FIGS. 3 and 4 show the operation of the hybrid screen printing system.

### DETAILED DESCRIPTION OF THE INVENTION

The hybrid screen printing system (100) will be described in greater detail with reference to the drawings.

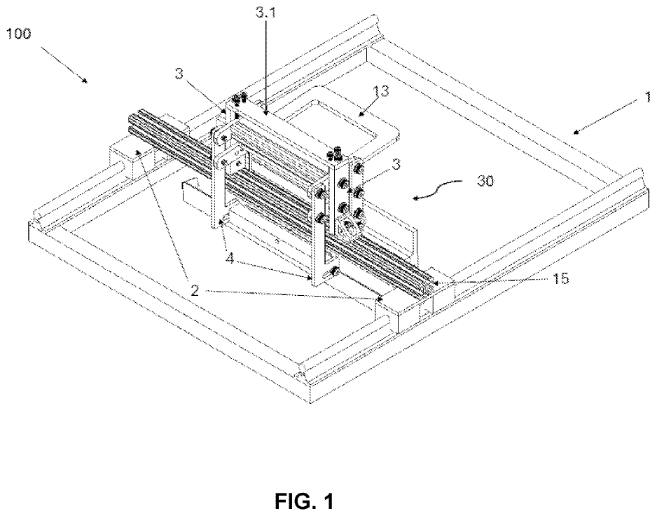

FIG. 1 is a perspective view showing the hybrid screen printing system (100) comprising a screen printing screen (1) and a printing mechanism (30) mounted on two linear bearings (2) through a bar (15). The linear bearings (2) allow the printing mechanism (30) to move along the screen printing screen (1) during a printing process to be performed.

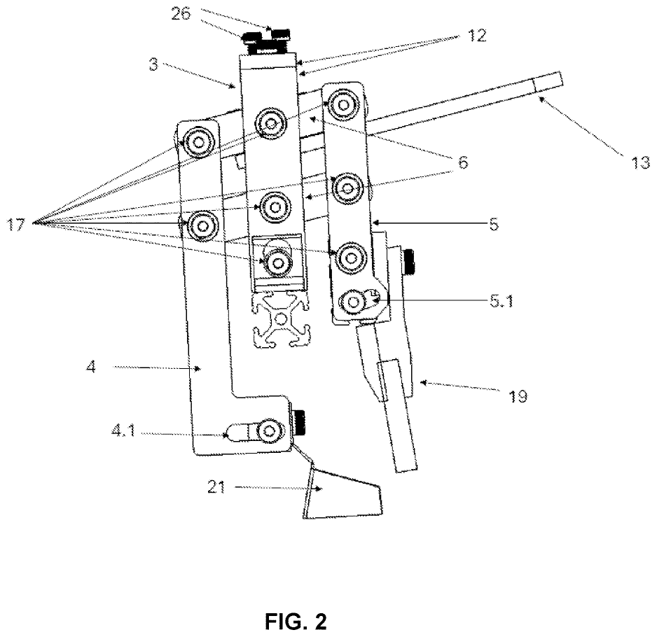

FIG. 2 shows the printing mechanism (30) in a side view. The printing mechanism (30) comprises an ink squeegee (21) coupled to a first set of arms (4) by means of a linear slot (4.1) in the first set of arms (4), wherein said linear slot (4.1) allows a movement of the first ink squeegee (21) with respect to the first set of arms (4). The first set of arms (4) is configured to perform a vertical movement to move the ink squeegee (21) away from or towards the screen-printing screen (1) to prepare the ink on the screen printing screen (1). A squeegee (19) coupled to a second set of arms (5) by means of a circular slot (5.1) which allows the squeegee (19) to be moved with respect to the second set of arms (5) to modify a printing angle of the squeegee (19). The second set of arms (5) is also configured to perform a vertical movement to move the squeegee (19) away from or towards to the screen printing screen (1) and deposit the ink that is on the screen printing screen (1) onto the product to be printed.

An inverted U-shaped mechanism support (12) arranged vertically between the first set of arms (4) and the second set of arms (5). The mechanism support (12) comprises a third set of arms (3) joined by a transverse element (3.1) that couples said third set of arms (3) and on said transverse element (3.1) mechanical stops (26) are arranged that will serve as end-of-travel stops.

A print shift lever (13) configured to manually activate a reciprocating motion between the ink squeegee (21) and the squeegee (19). A plurality of horizontal arms (6) serving as a join between the first set of arms (4), the second set of arms (5), and the third set of arms (3), and a plurality of shoulder screws (17) serving to join the first set of arms (4), the second set of arms (5), and the third set of arms (3) and the plurality of horizontal arms (6) and facilitate relative movement therebetween. The print shift lever (13) is coupled to the plurality of horizontal arms (6). 1. The plurality of shoulder screws (17) comprise a first set of screws for attaching the first set of arms (4) to the plurality of horizontal arms (6), a second set of screws for attaching the second set of arms (5) to the plurality of horizontal arms (6), and a third set of screws configured to attach the third set of arms (3) to the plurality of horizontal arms (6). The third set of screws are further configured to allow pivotal movement between the first set of arms (4) and the second set of arms (5) relative to the third set of arms (3), such that when the print change lever (13) is moved upward in a direction away from the screen printing screen (1), the first set of arms (4) moves downward in a direction toward the screen printing screen (1), while the second set of arms (5) moves in the opposite direction to the screen printing screen (1).

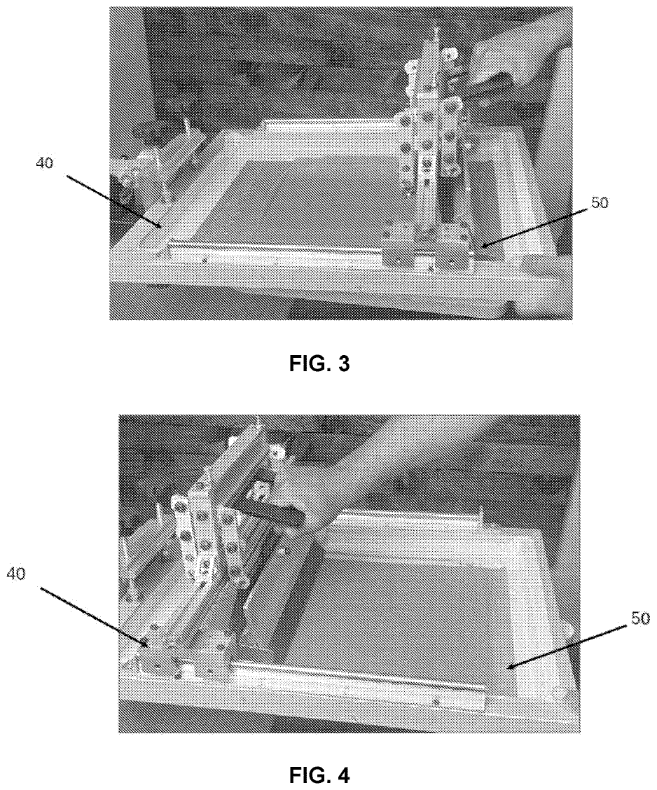

As can be seen from FIGS. 3 and 4, the printing mechanism (30) will start its movement on the screen printing screen (1) from its initial state with the linear bearings (2) located at a first end (40) of the screen printing screen (1), wherein said first set of arms (4) is arranged downwards in the direction towards the screen printing screen (1) while the second set of arms (5) is arranged upwards in the opposite direction to the screen printing screen (1), so that in this position an operator will move the printing mechanism (30) towards a second end (50) of the screen printing screen (1) longitudinally opposite to the first end (40), using the linear bearings (2) and thus preparing the ink by means of the ink squeegee (21) on the screen printing screen (1). Once the printing mechanism (30) reaches the second end (50) of the screen printing screen (1), the operator will activate the printing change lever (13) with which the first set of arms (4) will be lifted and moved in the opposite direction to the screen printing screen (1) and the second set of arms (5) will move in the direction towards the screen printing screen (1) so as to bring the squeegee (19) into contact with the screen printing screen (1).

When the squeegee (19) is in contact with the screen printing screen (1) the operator will push the printing mechanism (30) from the second end (50) towards the first end (40) using the linear bearings (2) to deposit the ink on a product to be printed.

The printing mechanism (30) will be made of standard materials. There are no restrictions on the materials to be used.

Any conventional squeegee (19) may be used. These parts are conventional in screen printing.

Any conventional ink squeegee (21) can be used. These parts are conventional for screen printing.

Any conventional screen printing screen (1) can be used. These parts are conventional for screen printing.

1. A screen printing mechanism (30) comprising:
A first set of arms (4) comprising an ink squeegee (21) configured to prepare ink on a screen printing screen (1);
A second set of arms (5) comprising a squeegee (19) configured to deposit the ink on the screen printing screen (1) on a product to be printed;
A mechanism support (12) comprising a third set of arms (3);
A plurality of horizontal arms (6) connecting the first set of arms (4), the second set of arms (5) and the third set of arms (3) by means of a plurality of shoulder screws (17); and
A print shift lever (13) configured to move the first set of arms (4) and the second set of arms (5) toward or away from the screen printing screen (1);
The printing mechanism (30) characterized in that when the printing change lever (13) moves the first set of arms (4) in a direction toward the screen printing screen (1), the second set of arms (5) moves in a direction opposite to the screen printing screen (1), and vice versa.

2. The screen printing mechanism according to claim 1, characterized in that it comprises a longitudinal bar (15) configured to arrange the screen printing mechanism (30) on linear bearings (2) configured to control a linear movement of the printing mechanism along the screen printing screen.

3. The screen printing mechanism, according to claim 1, characterized in that said printing mechanism is configured to pull and prepare the ink on the screen printing screen, as well as deposit the ink on the product to be printed.

4. The screen printing mechanism according to claim 3, characterized in that the third set of arms (3) comprises a third set of screws of the plurality of shoulder screws (17) that are configured as pivots to perform a pivot movement of the first set of arms (4) and the second set of arms (5) with respect to the third set of arms (3).

5. The screen printing mechanism according to claim 1, characterized in that the first set of arms (4) comprises two opposite arms for holding the ink squeegee (21) by means of a linear slot (4.1) configured to adjust the position of the ink squeegee (21).

6. The screen printing mechanism according to claim 1, characterized in that the second set of arms (5) comprises two opposite arms for holding the squeegee (19) by means of a circular slot (5.1) configured to adjust an angle of the squeegee (19).

7. The screen printing mechanism according to claim 1, characterized in that it further comprises mechanical stops configured to adjust a stroke of both the ink squeegee and the printing squeegee.

8. A hybrid screen printing system (100) comprising:
A screen printing mechanism (30) according to claim 1;
A screen printing screen (1); and
linear bearings (2);
Wherein the linear bearings (2) are arranged on rails arranged longitudinally on the screen printing screen (1), such that said linear bearings (2) are configured to support the screen printing mechanism (30) and move along said rails.
